(19) United States
(12) Patent Application Publication
(10) Pub. No.: US 2026/0187477 A1
(43) Pub. Date: Jul. 2, 2026

(54) METHOD AND DEVICE FOR ADDRESSING CATASTROPHIC FORGETTING IN ARTIFICIAL NEURAL NETWORKS USING NEUROMIMETIC METAPLASTICITY RULES OBSERVED IN NATURAL BRAINS

(71) Applicant: Korea Advanced Institute of Science and Technology, Daejeon (KR)

(72) Inventors: Se-Bum PAIK, Daejeon (KR); Seungdae BAEK, Daejeon (KR); Suhee CHO, Daejeon (KR); Hyeonsu LEE, Daejeon (KR)

(73) Assignee: Korea Advanced Institute of Science and Technology, Daejeon (KR)

(21) Appl. No.: 19/193,013

(22) Filed: Apr. 29, 2025

(30) Foreign Application Priority Data
Dec. 30, 2024 (KR) 10-2024-0199987

(51) Int. Cl. G06N 3/096

(52) U.S. Cl. CPC G06N 3/096

(57) ABSTRACT

Disclosed is a method and device for addressing catastrophic forgetting in artificial neural network learning by applying metaplasticity rules of the biological brain, which may be configured to assign different flexibility values to a plurality of synapses of an artificial neural network, respectively; and to store information on at least one task through the synapses while performing learning for the at least one task using the artificial neural network. The present disclosure may adjust weights of the synapses according to the flexibility values assigned to the synapses, respectively, while performing learning for each task, and may store information on the task based on the weights through the synapses.

### CROSS-REFERENCE TO RELATED APPLICATION(S)

This application claims the priority benefit of Korean Patent Application No. 10-2024-0199987, filed on Dec. 30, 2024, in the Korean Intellectual Property Office, the disclosure of which is incorporated herein by reference.

### BACKGROUND

### 1. Field of the Invention

Example embodiments of the present disclosure relate to a method and a device for addressing catastrophic forgetting in artificial neural network learning by applying metaplasticity rules of the biological brain.

### 2. Description of the Related Art

In various artificial intelligence fields using deep neural networks such as artificial intelligence assistants and large language models, it is important to retain existing learned information while learning and applying newly given information. However, when a neural network learns new information, there is an issue called catastrophic forgetting that previously learned information is lost.

Some methods are proposed to solve this issue. In detail, a first method attempts to solve catastrophic forgetting by storing information on a learning task in a synapse and selectively retaining the connection strength. However, this requires a large amount of computation since the connection strength of previous synapses needs to be readjusted every time new information is learned. A second method suggests increasing the size of a neural network or adding an external memory in response to an increase in an amount of new input information, but it is difficult to apply in a realistic situation in which the capacity of the neural network may not be arbitrarily changed during a learning process. A third method introduces an additional process such as determining whether information being learned is necessary and then storing the same in a long-term memory, but it is difficult to apply to a real task considering the effectiveness or speed of learning. A fourth method suggests the principle that flexible information storage is possible in the neural network in which various types of synapses are shuffled, but this is a model based on a biological spike neural network and cannot be applied to a convolutional neural network, which is commonly used for practical tasks, such as object recognition/discrimination.

Most common techniques focus only on the goal of memorizing learned information with high accuracy. However, the actual brain shows the flexible information storage ability that secures storage capacity by sacrificing accuracy according to a situation, rather than storing all learned information with perfect accuracy. Various biological information storage characteristics observed in the brain, for example, the characteristic of flexibly adjusting the accuracy and the storage capacity, the characteristic of strengthening memory through repetitive learning to not be affected by contaminated information or noise, and the characteristic of memorizing information that is repeated at high frequency rather than information that is not frequently repeated, may be very useful in various tasks that utilize actual deep neural networks, however, are not yet sufficiently utilized in conventional artificial neural network learning.

### SUMMARY

The present disclosure provides a method and device for addressing catastrophic forgetting in artificial neural network learning by applying metaplasticity rules of the biological brain.

According to the present disclosure, there is provided an operating method of a computing device for addressing catastrophic forgetting in artificial neural network learning by applying metaplasticity rules of the biological brain, the method including assigning different flexibility values to a plurality of synapses of an artificial neural network, respectively; and storing information on at least one task through the synapses while performing learning for the at least one task using the artificial neural network, wherein the storing of the information on the at least one task includes adjusting weights of the synapses according to the flexibility values assigned to the synapses, respectively, while performing learning for each task; and storing information on the task based on the weights through the synapses.

According to the present disclosure, there is provided a computing device for addressing catastrophic forgetting in artificial neural network learning by applying metaplasticity rules of the biological brain, the computing device including a memory; and a processor configured to execute at least one instruction stored in the memory through connection to the memory, and to assign different flexibility values to a plurality of synapses of an artificial neural network, respectively, and to store information on at least one task through the synapses while performing learning for the at least one task using the artificial neural network, wherein the processor is configured to adjust weights of the synapses according to the flexibility values assigned to the synapses, respectively, while performing learning for each task, and to store information on the task based on the weights through the synapses.

According to the present disclosure, there is provided a non-transitory computer-readable recording medium storing a computer program to execute a method of addressing catastrophic forgetting in artificial neural network learning by applying metaplasticity rules of the biological brain, wherein the method includes assigning different flexibility values to a plurality of synapses of an artificial neural network, respectively; and storing information on at least one task through the synapses while performing learning for the at least one task using the artificial neural network, and the storing of the information on each of the tasks includes adjusting weights of the synapses according to the flexibility values assigned to the synapses, respectively, while performing learning for each task; and storing information on the task based on the weights through the synapses.

According to the present disclosure, by performing learning for a plurality of tasks using an artificial neural network to which metaplasticity rules are applied, it is possible to store information at each stage with at least a certain level of storage accuracy, while storing the information up to the maximum possible storage capacity, and catastrophic forgetting that information on a previous task is lost may be prevented during this process. In the artificial neural network of the present disclosure, a flexible information storage function may be automatically implemented without any additional computational process. The performance of the artificial neural network of the present disclosure may be enhanced through repetitive learning and may not be damaged although noise or contaminated data is presented as a training dataset later.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a computing device for addressing catastrophic forgetting in artificial neural network learning by applying metaplasticity rules of the biological brain according to the present disclosure;

FIG. 2 is a view for describing operational characteristics of the computing device of FIG. 1;

FIG. 3 is a view for describing the performance of the computing device of FIG. 1;

FIG. 4 is a view for describing a first experiment and its results for comparing an artificial neural network of the present disclosure and a conventional artificial neural network;

FIG. 5 is a view for describing a second experiment and its results for comparing the artificial neural network of the present disclosure and the conventional artificial neural network;

FIG. 6 is a view for describing a third experiment and its results for comparing the artificial neural network of the present disclosure and the conventional artificial neural network;

FIG. 7 is a view for describing a fourth experiment and its results for comparing the artificial neural network of the present disclosure and the conventional artificial neural network;

FIG. 8 is a view for describing a fifth experiment and its results for comparing the artificial neural network of the present disclosure and the conventional artificial neural network; and

FIG. 9 is a flowchart illustrating an operating method of a computing device for addressing catastrophic forgetting in artificial neural network learning by applying metaplasticity rules of the biological brain according to the present disclosure.

### DETAILED DESCRIPTION

Hereinafter, the present disclosure provides a method and device for addressing catastrophic forgetting in artificial neural network learning by applying metaplasticity rules of the biological brain.

The present disclosure implements a continual learning method that may be universally applied to an artificial neural network without a complex intermediate process, such as considering a change in a physical structure of a neural network or correlation between information, based on characteristics of synaptic plasticity observed in the human brain. In detail, the present disclosure presents that, if each synapse has a different degree of flexibility and stability by applying synaptic metaplasticity rules to the artificial neural network, catastrophic forgetting is minimized during sequential information learning and flexible information storage like human working memory is possible. That is, by simply multiplying the learning law of the conventional artificial neural network by a simple metaplasticity function, it is possible to maintain the storage accuracy of each piece of information to be more than or equal to a certain level, while storing the information up to the maximum possible storage capacity, suppressing catastrophic forgetting from occurring in this process. The flexible information storage function may be automatically implemented in the artificial neural network to which technology of the present disclosure is applied, without an additional computational process. Information memorized in this manner may be enhanced with some repetitive learning and is not damaged although noise or contaminated data is presented as a training dataset.

The present disclosure may be applied to various neural network models that simulate the brain, and may also be applied to almost all types of neural network models currently in widespread use, such as AlexNet or ResNet and even a large language model and thus, is universal unlike the conventional art. That is, the present disclosure proposes a general learning or information storage algorithm and is not limited to a specific neural network type/structure, and learning model. This is a model that may be universally applied to any types of neural network models and may be equally applied to a hardware system, such as a neuromorphic system, without a separate process.

Hereinafter, various example embodiments of the present disclosure are described with reference to the accompanying drawings.

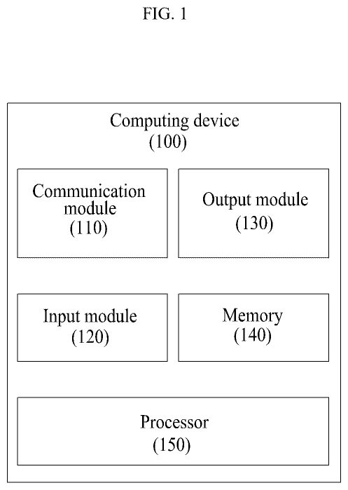

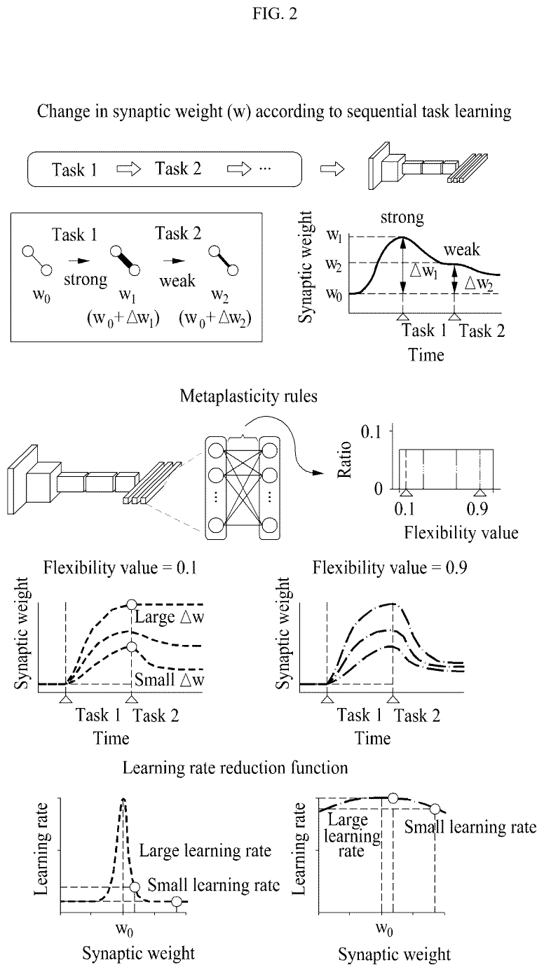

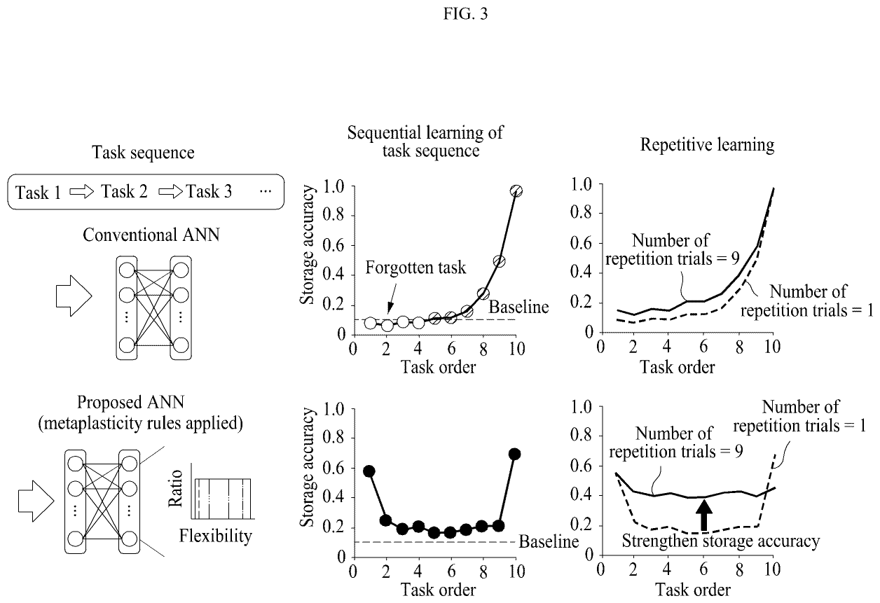

FIG. 1 is a diagram illustrating a computing device 100 for addressing catastrophic forgetting in artificial neural network learning by applying metaplasticity rules of the biological brain according to the present disclosure, FIG. 2 is a view for describing operational characteristics of the computing device 100 of FIG. 1, and FIG. 3 is a view for describing performance of the computing device 100 of FIG. 1.

Referring to FIG. 1, the computing device 100 relates to addressing catastrophic forgetting in artificial neural network learning by applying metaplasticity rules of the biological brain, and may include at least one of a communication module 110, an input module 120, an output module 130, a memory 140, and a processor 150. In some example embodiments, at least one of components of the computing device 100 may be omitted and at least one another component may be added. In some example embodiments, at least two of the components of the computing device 100 may be implemented as a single integrated circuit.

The communication module 110 may perform communication with an external device in the computing device 100. The communication module 110 may establish a communication channel between the computing device 100 and the external device and may perform communication with the external device through the communication channel. For example, the external device may include at least one of another computing device, a server, a base station, and a satellite. The communication module 110 may include at least one of a near field communication module and a far field communication module. The near field communication module may communicate with the external device using a near field communication scheme. For example, the near field communication scheme may include at least one of Bluetooth, WiFi direct, and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) or a wide area network (WAN).

The input module 120 may input a signal to be used to at least one component of the computing device 100. The input module 120 may be configured to generate a signal by detecting a signal directly input from a user or by detecting an ambient change. For example, the input module 120 may include at least one of a mouse, a keypad, a microphone, and a sensing module having at least one sensor. In some example embodiments, the input module 120 may include at least one of a touch circuitry set to detect a touch and a sensor circuitry set to measure intensity of a force generated by the touch.

The output module 130 may output information to the outside of the computing device 100. The output module 130 may include at least one of a display module configured to visually output information and an audio output module configured to output information as an audio signal. For example, the audio output module may include at least one of a speaker and a receiver.

The memory 140 may store a variety of data used by at least one component of the computing device 100. For example, the memory 140 may include at least one of a volatile memory and a nonvolatile memory. Data may include at least one program and input data or output data related thereto. A program may be stored as software that includes at least one instruction in the memory 140, and may include at least one of an operating system (OS), middleware, and an application.

The processor 150 may control at least one component of the computing device 100 by executing the program of the memory 140. Through this, the processor 150 may perform data processing or operations. Here, the processor 150 may execute an instruction stored in the memory 140. In various example embodiments, the processor 150 may address catastrophic forgetting in artificial neural network learning by applying metaplasticity rules of the biological brain. The metaplasticity rules may be implemented in such a manner that a weight (w) of each of a plurality of synapses of an artificial neural network is adjusted according to each corresponding flexibility.

The processor 150 may implement a state in which metallicity values, that is, flexibility values of the plurality of synapses of the artificial neural network are randomly shuffled, thereby granting the human's adaptive sequential learning ability. In detail, the processor 150 may assign different flexibility values to synapses of the artificial neural network, respectively. Here, the flexibility values may be within the range between the lower limit and the upper limit. For example, the lower limit may be 0 and the upper limit may be 1. The closer the flexibility value is to the lower limit, the more stable a corresponding synapse may be such that its weight (w) does not easily change, and the closer the flexibility value is to the upper limit, the more flexible, that is, unstable, the corresponding synapse may be such that its weight (w) easily changes. Based on this, the processor 150 may sequentially perform learning for a plurality of tasks (e.g., task 1, task 2, . . . ) using the artificial neural network and may store information on each of the tasks through synapses. In detail, the processor 150 may adjust weights (w) of the synapses according to flexibility values assigned to the synapses, respectively, and may store task information based on the weights (w) through the synapses, while performing learning for each task.

As shown in FIG. 2, in learning for each task, the processor 150 may adjust each of the weights (w) of the synapses in the following manner. That is, the processor 150 may adjust each of the synapses to a new weight (wₙ₊₁). The processor 150 may determine, for each of the synapses, a weight adjustment width (Δwₙ₊₁, n=0, 1, 2, . . . , for example, Δw₁ in learning for task 1 and Δw₂ in learning for task 2) from an initial weight (w₀) before performing learning according to a flexibility value. The closer the flexibility value is to the lower limit, the smaller the weight adjustment width (Δwₙ₊₁) may be, and the closer the flexibility value is to the upper limit, the larger the weight adjustment width (Δwₙ₊₁) may be. The processor 150 may determine the new weight (wₙ₊₁) using the combination of the flexibility value, the previous weight (wₙ), and the weight adjustment width (Δwₙ₊₁). In some example embodiments, the processor 150 may detect a downscaled learning rate from a previous learning rate based on the flexibility value and the weight adjustment width (Δwₙ₊₁), and may determine the new weight (wₙ₊₁) using the combination of the previous weight (wₙ) and the downscaled learning rate. The closer the flexibility value is to the lower limit, the larger the learning rate may be downscaled, and the closer the flexibility value is to the upper limit, the smaller the learning rate may be downscaled. For example, the new weight (wₙ₊₁) may be determined using [Equation 1] and [Equation 2] below.

$${w}_{n + 1} := {w}_{n} - [ S ( flexibility , Δ {w}_{n + 1} ) \cdot n ] \frac{\partial }{\partial w} J ( {w}_{n} ) \qquad [ Equation 1 ]$$

Here, w denotes a weight of a synapse, wₙ denotes a previous weight, wₙ₊₁ denotes a new weight, Δwₙ₊₁ denotes a weight adjustment width, n denotes a previous learning trial, n+1 denotes a new learning trial, η denotes a learning rate, J(⋅) denotes a loss function, and S(⋅) denotes a learning rate reduction function, which may be determined as shown [Equation 2] below.

$$S ( flexibility , Δ w ) = 1 - {tanh}^{2} ( α \frac{1 - flexibility}{flexibility} \cdot Δ w ) \qquad [ Equation 2 ]$$

Here, flexibility denotes a flexibility value and a denotes a hyperparameter that adjusts the width of S(⋅).

According to various example embodiments, by applying metaplasticity rules, the learning phenomenon that appears in the brain's working memory, such as the serial position effect and the Hebb repetition effect, may spontaneously appear in the artificial neural network. That is, as shown in FIG. 3, when proceeding with learning for a plurality of tasks, information on a new task may be learned while retaining information on a previous task. Also, as shown in FIG. 3, the storage accuracy for each task may be improved as the task is repeatedly learned. That is, the metaplasticity rules may allow the artificial neural network to adaptively utilize storage capacity similar to the human's flexible memory. In detail, the processor 150 may store information according to the storage capacity of each of the tasks through synapses, while repeatedly performing learning according to learning frequency set for each of the tasks using the artificial neural network. Here, when the learning frequency is set to be the same for the tasks, the storage capacity may be evenly distributed across the tasks and when the learning frequency is set to be different for the tasks, a portion of the storage capacity of a task with a low learning frequency may be redistributed to a task with a high learning frequency.

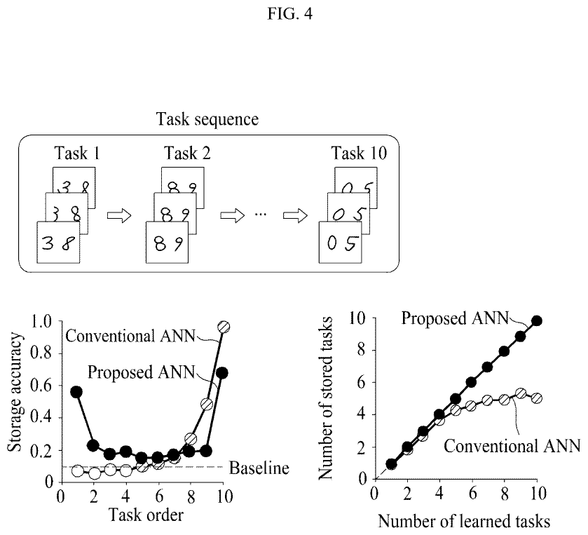

FIG. 4 is a view for describing a first experiment and its results for comparing an artificial neural network of the present disclosure and a conventional artificial neural network.

Referring to FIG. 4, to compare the artificial neural network (ANN) of the present disclosure and the conventional artificial neural network, the experiment of sequentially performing learning for ten tasks was conducted. Here, AlexNet was used as the artificial neural network of the present disclosure and the conventional artificial neural network, and in the artificial neural network of the present disclosure, metaplasticity rules were applied to a fully connected layer. That is, a state in which flexibility values of synapses of the fully connected layer were randomly shuffled was implemented. Here, the flexibility values may range from 0 to 1. As shown in FIG. 4, using the artificial neural network of the present disclosure and the conventional artificial neural network, learning for ten tasks was sequentially performed. Here, the task sequence was determined in which ten tasks were sequentially defined and the tasks involved classifying images of different two-digit numbers.

As a result, as shown in FIG. 4, the artificial neural network of the present disclosure and the conventional artificial neural network showed the difference in the storage accuracy for each task and the number of tasks in which information was stored. In detail, the catastrophic forgetting effect of strongly memorizing recent task information and forgetting previous task information below a baseline was observed in the conventional artificial neural network. On the other hand, the serial position effect of retraining the storage accuracy of previous tasks was observed in the artificial neural network of the present disclosure, and accordingly, the storage accuracy of all ten tasks was maintained above the baseline.

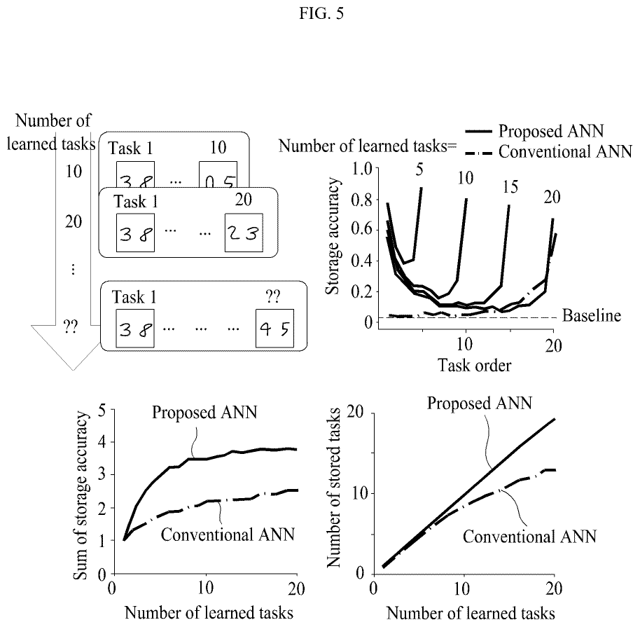

FIG. 5 is a view for describing a second experiment and its results for comparing the artificial neural network of the present disclosure and the conventional artificial neural network.

Referring to FIG. 5, to compare the artificial neural network of the present disclosure and the conventional artificial neural network, the experiment of sequentially performing learning for tasks was conducted while increasing the number of tasks. Here, the artificial neural network of the present disclosure and the conventional artificial neural network were configured in the same manner as in the experiment described above. As shown in FIG. 5, using the artificial neural network of the present disclosure and the conventional artificial neural network, learning for tasks was sequentially performed while increasing the number of tasks. Here, different task sequences were determined in which different numbers of tasks were sequentially defined, respectively, and the tasks involved classifying different two-digit number images.

As a result, as shown in FIG. 5, the artificial neural network of the present disclosure and the conventional artificial neural network showed the difference in the sum of storage accuracy according to the number of tasks and the number of tasks in which information was stored, even in a situation in which the total number of tasks being learned was increasing. In detail, in the artificial neural network of the present disclosure, the sum of storage accuracy according to the number of tasks was maintained at a certain level, and at the same time, the number of tasks for which the storage accuracy was retained to be greater than or equal to the baseline increased. That is, the present disclosure may allow the artificial neural network to automatically redistribute the storage capacity in a situation in which the number of tasks to be learned is not known in advance, which may lead to allowing previous tasks and new tasks to be memorized above the baseline.

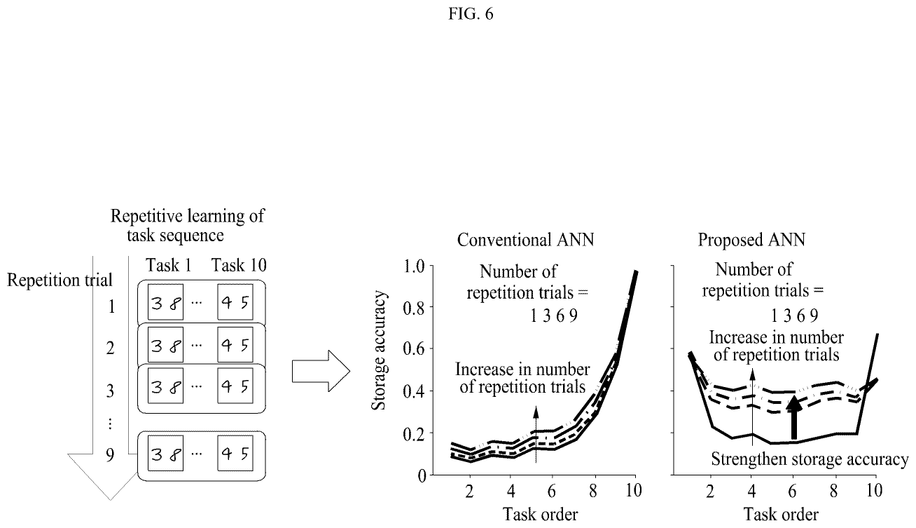

FIG. 6 is a view for describing a third experiment and its results for comparing the artificial neural network of the present disclosure and the conventional artificial neural network.

Referring to FIG. 6, to compare the artificial neural network of the present disclosure and the conventional artificial neural network, particularly, to improve the storage accuracy of tasks present in the middle of a task sequence in the artificial neural network of the present disclosure, the experiment of repeatedly performing learning for the same task sequence was conducted. Here, the artificial neural network of the present disclosure and the conventional artificial neural network were configured in the same manner as in the experiments described above. As shown in FIG. 6, using the artificial neural network of the present disclosure and the conventional artificial neural network, learning for the same task sequence was performed nine repetition trials. Here, the task sequence was determined in which ten tasks were sequentially defined and the tasks involved classifying different two-digit number images.

As a result, as shown in FIG. 6, the artificial neural network of the present disclosure and the conventional artificial neural network showed the difference in the storage accuracy of tasks of the task sequence. In detail, the increase effect in the storage accuracy according to repetition was not prominent in the conventional artificial neural network. On the other hand, in the artificial neural network of the present disclosure, the Hebb repetition effect of working memory was reproduced and the storage accuracy of tasks constituting the task sequence increased overall. In particular, the storage accuracy of tasks present in the middle of the task sequence was greatly improved. This represents that, as learning for the task sequence is repeated, the memory ability of a task showing relatively low storage accuracy is strengthened and the accuracy storage gap between tasks constituting the task sequence is reduced, which represents that the storage capacity is evenly distributed between the tasks.

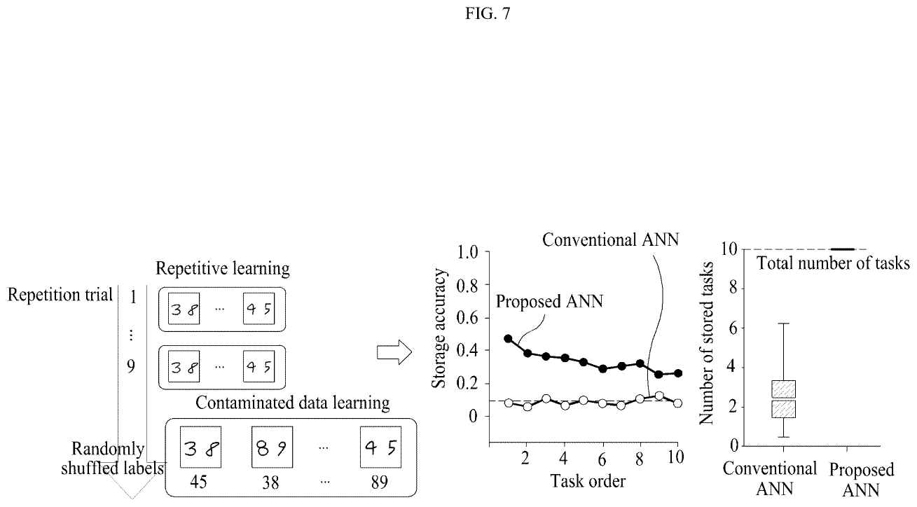

FIG. 7 is a view for describing a fourth experiment and its results for comparing the artificial neural network of the present disclosure and the conventional artificial neural network.

Referring to FIG. 7, to compare the artificial neural network of the present disclosure and the conventional artificial neural network, particularly, to show that memory strengthened through repetitive learning in the artificial neural network of the present disclosure is not easily damaged by exposure to contaminated data, the experiment of performing learning for the same task sequence nine repetition trials and then performing learning for intentionally contaminated (incorrect) data (data poisoning attack) was conducted. Here, the artificial neural network of the present disclosure and the conventional artificial neural network were configured in the same manner as in the experiments described above. As shown in FIG. 7, using the artificial neural network of the present disclosure and the conventional artificial neural network, learning for the contaminated data was performed after performing learning for the same task sequence nine repetition trials. Here, the task sequence was determined in which ten tasks were sequentially defined and the tasks involved classifying different two-digit number images and, based on this, contaminated data was created.

As a result, as shown in FIG. 7, the artificial neural network of the present disclosure and the conventional artificial neural network showed the difference in the storage accuracy of tasks of the task sequence. In detail, in the conventional artificial neural network, after exposure to the contaminated data, the memory for all tasks was reduced to a baseline level and none of the tasks constituting the task sequence were memorized. On the other hand, the artificial neural network of the present disclosure still memorized all tasks above the baseline eve after exposure to the contaminated data. This suggests that information on tasks learned through repetitive learning is not easily damaged even when exposed to the contaminated data.

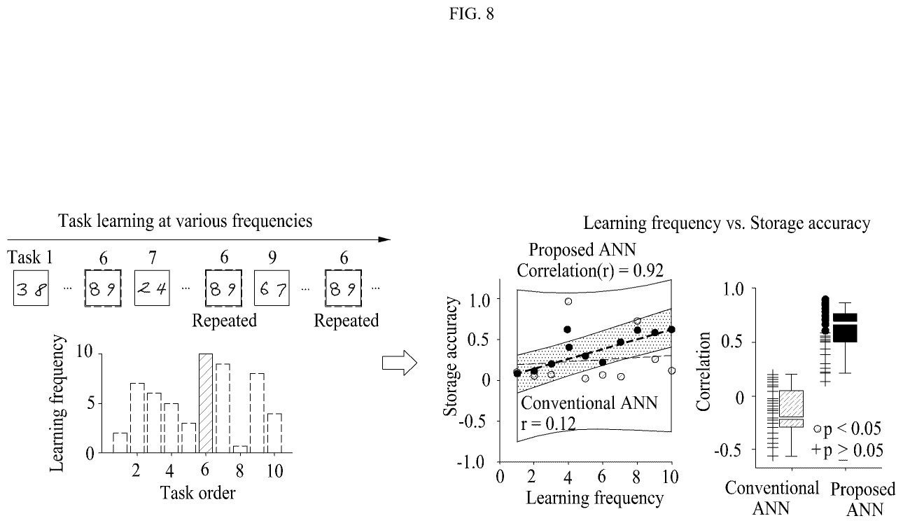

FIG. 8 is a view for describing a fifth experiment and its results for comparing the artificial neural network of the present disclosure and the conventional artificial neural network.

Referring to FIG. 8, to compare the artificial neural network of the present disclosure and the conventional artificial neural network, the experiment of setting different learning frequencies and performing learning for tasks according to the learning frequencies was conducted. Here, the artificial neural network of the present disclosure and the conventional artificial neural network were configured in the same manner as in the experiments described above. As shown in FIG. 8, using the artificial neural network of the present disclosure and the conventional artificial neural network, learning was sequentially performed for tasks set at different learning frequencies. Here, the task sequence was determined in which ten tasks were sequentially defined and the tasks involved different two-digit number images.

As a result, as shown in FIG. 8, the artificial neural network of the present disclosure and the conventional artificial neural network showed the difference in change in the storage accuracy according to the difference in learning frequencies of tasks included in the task sequence. In detail, in the conventional artificial neural network, the storage accuracy of each task showed a higher correlation with the order in the task sequence, not a learning frequency of the corresponding task. On the other hand, in the artificial neural network of the present disclosure, the storage accuracy of the task showed a higher correlation with the learning frequency, not the order in the task sequence. In the artificial neural network of the present disclosure, the storage capacity is allocated based on the importance of the corresponding task, not the learning order of the task. That is, when there is a difference in learning frequency between tasks, the artificial neural network of the present disclosure redistributes the storage capacity of a task with a low learning frequency to a task with a high learning frequency, selectively forgetting the task with the low learning frequency and strongly memorizing the task with the high learning frequency.

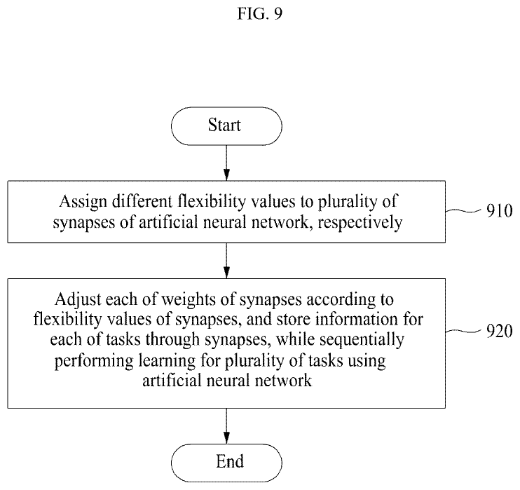

FIG. 9 is a flowchart illustrating an operating method of the computing device 100 for addressing catastrophic forgetting in artificial neural network learning by applying metaplasticity rules of the biological brain according to the present disclosure.

Referring to FIGS. 1 and 9, in operation 910, the computing device 100 may implement a state in which metaplasticity values, that is, flexibility values of a plurality of synapses of an artificial neural network are randomly shuffled. In detail, the processor 150 may assign different flexibility values to synapses of the artificial neural network, respectively. Here, the flexibility values may be within the range between the lower limit and the upper limit. For example, the lower limit may be 0 and the upper limit may be 1. The closer the flexibility value is to the lower limit, the more stable a corresponding synapse may be such that its weight (w) does not easily change, and the closer the flexibility value is to the upper limit, the more flexible, that is, unstable, the corresponding synapse may be such that its weight (w) easily changes.

In operation 920, the computing device 100 may store information for each of the tasks through synapses while sequentially performing learning for a plurality of tasks using the artificial neural network. In detail, the processor 150 may adjust weights (w) of the synapses according to the flexibility values assigned to the synapses, respectively, and may store task information based on the weights (w) through the synapses, while performing learning for each task.

As shown in FIG. 2, in learning for each task, the processor 150 may adjust the weights (w) of the synapses in the following manner. That is, the processor 150 may adjust each of the synapses to a new weight (wₙ₊₁). The processor 150 may determine, for each of the synapses, a weight adjustment width (Δwₙ₊₁, n=0, 1, 2, . . . , for example, Δw₁ in learning for task 1 and Δw₂ in learning for task 2) from an initial weight (w₀) before performing learning according to a flexibility value. The closer the flexibility value is to the lower limit, the smaller the weight adjustment width (Δwₙ₊₁) may be, and the closer the flexibility value is to the upper limit, the larger the weight adjustment width (Δwₙ₊₁) may be. The processor 150) may determine the new weight (wₙ₊₁) using the combination of the flexibility value, the previous weight (wₙ), and the weight adjustment width (Δwₙ₊₁). In some example embodiments, the processor 150 may detect a downscaled learning rate from a previous learning rate based on the flexibility value and the weight adjustment width (Δwₙ₊₁), and may determine the new weight (wₙ₊₁) using the combination of the previous weight (wₙ) and the downscaled learning rate. The closer the flexibility value is to the lower limit, the larger the learning rate may be downscaled, and the closer the flexibility value is to the upper limit, the smaller the learning rate may be downscaled. For example, the new weight (wₙ₊₁) may be determined using [Equation 1] and [Equation 2] above.

According to various example embodiments, by applying metaplasticity rules, the learning phenomenon that appears in the brain's working memory, such as the serial position effect and the Hebb repetition effect, may spontaneously appear in the artificial neural network. That is, as shown in FIG. 3, when proceeding with learning for a plurality of tasks, information on a new task may be learned while retaining information on a previous task. Also, as shown in FIG. 3, the storage accuracy for each task may be improved as the task is repeatedly learned. That is, the metaplasticity rules may allow the artificial neural network to adaptively utilize storage capacity similar to the human's flexible memory. In detail, the processor 150 may store information according to the storage capacity of each of the tasks through synapses, while repeatedly performing learning according to learning frequency set for each of the tasks refers to the artificial neural network. Here, when the learning frequency is set to be the same for the tasks, the storage capacity may be evenly distributed across the tasks and when the learning frequency is set to be different for the tasks, a portion of the storage capacity of a task with a low learning frequency may be redistributed to a task with a high learning frequency.

According to the present disclosure, by performing learning for a plurality of tasks using an artificial neural network to which metaplasticity rules are applied, it is possible to store information at each stage with at least a certain level of storage accuracy, while storing the information up to the maximum possible storage capacity and catastrophic forgetting that information on a previous task is lost may be prevented during this process. In the artificial neural network of the present disclosure, a flexible information storage function may be automatically implemented without any additional computational process. The performance of the artificial neural network of the present disclosure may be enhanced through repetitive learning and may not be damaged although noise or contaminated data is presented as a training dataset later.

In summary, the present disclosure provides the computing device 100 and an operating method thereof for addressing catastrophic forgetting in artificial neural network learning by applying metaplasticity rules of the biological brain.

Herein, an operating method of the computing device 100 may include assigning different flexibility values to a plurality of synapses of an artificial neural network, respectively, (operation 910) and storing information on at least one task through the synapses while performing learning for the at least one task using the artificial neural network (operation 920).

Herein, the performing the learning for at least one task using the artificial neural network may include performing learning for a single task or sequentially performing learning for a plurality of tasks.

Herein, the storing the of information on the at least one task (operation 920) may include adjusting weights (w) of the synapses according to the flexibility values assigned to the synapses, respectively, while performing learning for each task, and storing information on the task based on the weights (w) through the synapses.

Herein, the adjusting of the weights (w) of the synapses, respectively, may include determining, for each of the synapses, a weight adjustment width (Δwₙ₊₁) from an initial weight (w₀) before performing the learning according to a flexibility value, and determining a new weight (wₙ₊₁) using the combination of the flexibility value, a previous weight (wₙ), and the weight adjustment width (Δwₙ₊₁).

Herein, the flexibility values may be within the range of the lower limit and the upper limit, the closer the flexibility value is to the lower limit, the smaller the weight adjustment width (Δwₙ₊₁) may be, and the closer the flexibility value is to the upper limit, the larger the weight adjustment width (Δwₙ₊₁) may be.

Herein, the determining of the new weight (wₙ₊₁) may include detecting a downscaled learning rate from a previous learning rate based on the flexibility value and the weight adjustment width (Δwₙ₊₁), and determining the new weight (wₙ₊₁) using the combination of the previous weight (wₙ) and the downscaled learning rate.

Herein, the closer the flexibility value is to the lower limit, the larger the learning rate may be downscaled, and the closer the flexibility value is to the upper limit, the smaller the learning rate may be downscaled.

Herein, the lower limit may be 0, and the upper limit may be 1.

Herein, the new weight may be determined using [Equation 1] and [Equation 2].

Herein, the storing of the information on the at least one task may include storing the information according to the storage capacity of each of tasks through the synapses while repeatedly performing learning according to a learning frequency set for each of the plurality of tasks using the artificial neural network.

Herein, when the learning frequency is set to be the same for the tasks, the storage capacity may be evenly distributed across the tasks, and when the learning frequency is set to be different for the tasks, a portion of the storage capacity of a task with a low learning frequency may be redistributed to a task with high learning frequency.

Herein, the computing device 100 may include the memory 140 and the processor 150 configured to execute at least one instruction stored in the memory 140 through connection to the memory 140, and to assign different flexibility values to a plurality of synapses of an artificial neural network, respectively, and to store information on at least one task through the synapses while performing learning for the at least one task using the artificial neural network.

Herein, the performing of the learning for at least one task using the artificial neural network may include performing learning for a single task or sequentially performing learning for a plurality of tasks.

Herein, the processor 150 may be configured to adjust weights (w) of the synapses according to the flexibility values assigned to the synapses, respectively, while performing learning for each task, and to store information on the task based on the weights (w) through the synapses.

Herein, the processor 150 may be configured to determine, for each of the synapses, a weight adjustment width (Δwₙ₊₁) from an initial weight (w₀) before performing the learning according to a flexibility value, and to determine a new weight (wₙ₊₁) using the combination of the flexibility value, a previous weight (wₙ), and the weight adjustment width (Δwₙ₊₁).

Herein, the flexibility values may be within the range of the lower limit and the upper limit, the closer the flexibility value is to the lower limit, the smaller the weight adjustment width (Δwₙ₊₁) may be, and the closer the flexibility value is to the upper limit, the larger the weight adjustment width (Δwₙ₊₁) may be.

Herein, the processor 150 may be configured to detect a downscaled learning rate from a previous learning rate based on the flexibility value and the weight adjustment width (Δwₙ₊₁), and to determine the new weight (wₙ₊₁) using the combination of the previous weight (wₙ) and the downscaled learning rate.

Herein, the closer the flexibility value is to the lower limit, the larger the learning rate may be downscaled, and the closer the flexibility value is to the upper limit, the smaller the learning rate may be downscaled.

Herein, the lower limit may be 0, and the upper limit may be 1.

Herein, the new weight may be determined using [Equation 1] and [Equation 2].

Herein, the processor 150 may be configured to store the information according to the storage capacity of each of tasks through the synapses while repeatedly performing learning according to a learning frequency set for each of the plurality of tasks using the artificial neural network.

Herein, when the learning frequency is set to be the same for the tasks, the storage capacity may be evenly distributed across the tasks, and when the learning frequency is set to be different for the tasks, a portion of the storage capacity of a task with a low learning frequency may be redistributed to a task with a high learning frequency.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of recording methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. An operating method of a computing device for addressing catastrophic forgetting in artificial neural network learning by applying metaplasticity rules of the biological brain, the method comprising:
assigning different flexibility values to a plurality of synapses of an artificial neural network, respectively; and
storing information on at least one task through the synapses while performing learning for the at least one task using the artificial neural network,
wherein the storing of the information on the at least one task comprises:
adjusting weights of the synapses according to the flexibility values assigned to the synapses, respectively, while performing learning for each task; and
storing information on the task based on the weights through the synapses.

2. The method of claim 1, wherein the adjusting of the weights of the synapses, respectively, comprises:
determining, for each of the synapses, a weight adjustment width from an initial weight before performing the learning according to a flexibility value; and
determining a new weight using the combination of the flexibility value, a previous weight, and the weight adjustment width.

3. The method of claim 2, wherein:
the flexibility values are within the range of the lower limit and the upper limit,
the closer the flexibility value is to the lower limit, the smaller the weight adjustment width is, and
the closer the flexibility value is to the upper limit, the larger the weight adjustment width is.

4. The method of claim 3, wherein the determining of the new weight comprises:
detecting a downscaled learning rate from a previous learning rate based on the flexibility value and the weight adjustment width; and
determining the new weight using the combination of the previous weight and the downscaled learning rate.

5. The method of claim 4, wherein:
the closer the flexibility value is to the lower limit, the larger the learning rate is downscaled, and
the closer the flexibility value is to the upper limit, the smaller the learning rate is downscaled.

6. The method of claim 3, wherein the lower limit is 0 and the upper limit is 1.

7. The method of claim 2, wherein the new weight is determined as shown in [Equation i] below,
$${w}_{n + 1} := {w}_{n} - [ S ( flexibility , Δ {w}_{n + 1} ) \cdot n ] \frac{\partial }{\partial w} J ( {w}_{n} ) , \qquad [ Equation i ]$$
where w denotes a weight of a synapse, Δw denotes a weight adjustment width, n denotes a previous learning trial, n+1 denotes a new learning trial, η denotes a learning rate, J(⋅) denotes a loss function, and S(⋅) denotes a learning rate reduction function, and is determined as shown in [Equation ii] below,
$$S ( flexibility , Δ w ) = 1 - {tanh}^{2} ( α \frac{1 - flexibility}{flexibility} \cdot Δ w ) , \qquad [ Equation ii ]$$
where flexibility denotes a flexibility value and a denotes a hyperparameter of the width of S(⋅).

8. The method of claim 1, wherein the storing of the information on the at least one task comprises storing the information according to the storage capacity of each of tasks through the synapses while repeatedly performing learning according to a learning frequency set for each of the plurality of tasks using the artificial neural network.

9. The method of claim 8, wherein:
when the learning frequency is set to be the same for the tasks, the storage capacity is evenly distributed across the tasks, and
when the learning frequency is set to be different for the tasks, a portion of the storage capacity of a task with a low learning frequency is redistributed to a task with a high learning frequency.

10. A computing device for addressing catastrophic forgetting in artificial neural network learning by applying metaplasticity rules of the biological brain, the computing device comprising:
a memory; and
a processor configured to execute at least one instruction stored in the memory through connection to the memory, and to assign different flexibility values to a plurality of synapses of an artificial neural network, respectively, and to store information on at least one task through the synapses while performing learning for the at least one task using the artificial neural network,
wherein the processor is configured to,
adjust weights of the synapses according to the flexibility values assigned to the synapses, respectively, while performing learning for each task, and
store information on the task based on the weights through the synapses.

11. The computing device of claim 10, wherein the processor is configured to,
determine, for each of the synapses, a weight adjustment width from an initial weight before performing the learning according to a flexibility value, and
determine a new weight using the combination of the flexibility value, a previous weight, and the weight adjustment width.

12. The computing device of claim 11, wherein:
the flexibility values are within the range of the lower limit and the upper limit,
the closer the flexibility value is to the lower limit, the smaller the weight adjustment width is, and
the closer the flexibility value is to the upper limit, the larger the weight adjustment width is.

13. The computing device of claim 12, wherein the processor is configured to,
detect a downscaled learning rate from a previous learning rate based on the flexibility value and the weight adjustment width, and
determine the new weight using the combination of the previous weight and the downscaled learning rate.

14. The computing device of claim 13, wherein:
the closer the flexibility value is to the lower limit, the larger the learning rate is downscaled, and
the closer the flexibility value is to the upper limit, the smaller the learning rate is downscaled.

15. The computing device of claim 12, wherein the lower limit is 0 and the upper limit is 1.

16. The computing device of claim 11, wherein the new weight is determined as shown in [Equation iii] below,
$${w}_{n + 1} := {w}_{n} - [ S ( flexibility , Δ {w}_{n + 1} ) \cdot n ] \frac{\partial }{\partial w} J ( {w}_{n} ) \qquad [ Equation iii ]$$
where w denotes a weight of a synapse, Δw denotes a weight adjustment width, n denotes a previous learning trial, n+1 denotes a new learning trial, η denotes a learning rate, J(⋅) denotes a loss function, and S(⋅) denotes a learning rate reduction function, and is determined as shown in [Equation iv] below,
$$S ( flexibility , Δ w ) = 1 - {tanh}^{2} ( α \frac{1 - flexibility}{flexibility} \cdot Δ w ) , \qquad [ Equation iv ]$$
where flexibility denotes a flexibility value and a denotes a hyperparameter of the width of S(⋅).

17. The computing device of claim 10, wherein the processor is configured to store the information according to the storage capacity of each of tasks through the synapses while repeatedly performing learning according to a learning frequency set for each of the plurality of tasks using the artificial neural network.

18. The computing device of claim 17, wherein:
when the learning frequency is set to be the same for the tasks, the storage capacity is evenly distributed across the tasks, and
when the learning frequency is set to be different for the tasks, a portion of the storage capacity of a task with a low learning frequency is redistributed to a task with a high learning frequency.

19. A non-transitory computer-readable recording medium storing a computer program to execute a method of addressing catastrophic forgetting in artificial neural network learning by applying metaplasticity rules of the biological brain, wherein the method comprises:
assigning different flexibility values to a plurality of synapses of an artificial neural network, respectively; and
storing information on at least one task through the synapses while performing learning for the at least one task using the artificial neural network, and
wherein the storing of the information on each of the tasks comprises:
adjusting weights of the synapses according to the flexibility values assigned to the synapses, respectively, while performing learning for each task; and
storing information on the task based on the weights through the synapses.

20. The non-transitory computer-readable recording medium of claim 19, wherein the adjusting of the weights of the synapses, respectively, comprises:
determining, for each of the synapses, a weight adjustment width from an initial weight before performing the learning according to a flexibility value; and
determining a new weight using the combination of the flexibility value, a previous weight, and the weight adjustment width.
